(19) United States
(12) Patent Application Publication
(10) Pub. No.: US 2026/0307123 A1
(43) Pub. Date: Oct. 8, 2026

(54) EQUIPMENT AND METHOD FOR REMOVING A SUPERNATANT PHASE FROM A BODY OF WATER IN A POLLUTED GROUNDWATER

(71) Applicant: ENI S.P.A., Roma (RM) (IT)

(72) Inventors: Stefano LODA, Novara (NO) (IT); Francesca RUBERTELLI, Novara (NO) (IT)

(21) Appl. No.: 19/482,898

(22) PCT Filed: May 6, 2024
(86) PCT No.: PCT/IB2024/054384

§ 371 Date: Nov. 10, 2025

(30) Foreign Application Priority Data
May 8, 2023 (IT) 102023000009132

(51) Int. Cl. B09C 1/00; B01D 17/02; B01D 17/12; C02F 1/00; C02F 1/40; C02F 103/06

(52) U.S. Cl. CPC B09C 1/002; B01D 17/0214; B01D 17/12; B09C 1/007; C02F 1/001; C02F 1/40; B09C 2101/00; C02F 2103/06; C02F 2201/005; C02F 2201/006; C02F 2209/03; C02F 2301/08

(57) ABSTRACT

An equipment and related method for removing supernatant phases from a body of water, in particular for the remediation of water tables contaminated by non-aqueous organic phases present as separated phases. The equipment is equipped with sensors for determining the supernatant phase level and a hydrophobic filter for selective pollutant recovery.

### CROSS-REFERENCE TO RELATED APPLICATIONS

This application is a 35 U.S.C. § 371 National Stage patent application of PCT/IB2024/054384 filed 6 May 2024, which claims the benefit of Italian patent application 102023000009132 filed 8 May 2023, the disclosures of which are incorporated herein by reference in their entirety.

### TECHNICAL FIELD

The present disclosure relates to an equipment and related method for removing a supernatant fluid (Light Non Aqueous Phase Liquid—LNAPL) with a density lower than that of water from a body of water, in particular for the remediation of water tables contaminated by non-aqueous organic phases present as separated phases.

### BACKGROUND

The treatment of waters polluted by organic compounds and the remediation of hydrocarbon-contaminated water tables is a topical issue and, to date, much attention is given to this subject for the development of increasingly effective and cost-efficient technologies in order to purify contaminated sites.

Widespread use, improper disposal, and accidental spills and leaks of hydrocarbons, such as petroleum derivatives and organic solvents, have caused the formation of persistent sources of soil and groundwater contamination, which are dangerous due to their effects on the environment and human health. Depending on the density of the organic matter with respect to water, water-immiscible liquid layers which float, known as LNAPLs (Light Non Aqueous Phase Liquids), or which sink, known as DNAPLS (Dense Non Aqueous Phase Liquids), in the aquifer may be obtained. Several methods are known to date for treating contaminated waters, but all of them require an assigned operator for the activities of monitoring the thickness of the supernatant phase present in the groundwater, for positioning and activating and deactivating the pumps for recovery. Known remediation systems are also characterised by a recovery of significant amounts of water (even 50% more than the recovered supernatant phase) with related costs for the treatment or disposal as hazardous waste. The drive of the recovery pump is interrupted when the presence of water is observed in the collection tank and thus the entire pipeline rising from the groundwater is full of water. In addition, using the known systems, the recovery of the supernatant phase is done with a frequency that depends on the production of the piezometric well and on its position. Under these conditions, periods of accumulation of supernatant phase are originated within the piezometric well, slowing down the remediation procedure.

The methods known to date for treating contaminated waters can be summarised as follows.

Hydraulic containment is currently one of the most widely used systems for reducing groundwater contamination, although it started out as a containment technique. This technology consists of a series of draining wells (known as “barrier wells”), placed mainly transverse to the water outflow, whose action creates piezometric depression cones, drawing in the contamination plume and preventing it from migrating into the surrounding environment. The hydraulic containment is often coupled with a treatment system for the drained waters; hence the frequently used term Pump&Treat (P&T) technology. In the presence of LNAPL, the pumping system collects a mixture of the two phases and the separation treatment is then carried out on the surface.

The simultaneous Multi-Phase Extraction (MPE) consists of exerting, through vertical and horizontal wells, a significant depression in the unsaturated area at the level of the capillary fringe and at the level of the upper part of the saturated zone, with the aim of extracting vapours from the soil, any supernatant product and the dissolved phase. The MPE technique in its plant variants (DPE—Dual Phase Extraction, TPE—Two Phase extraction, Bioslurping) also provides for a separation of the recovered contaminant phases on the surface.

The Dual Pump method makes use of two independent pumps, inserted in the recovery well. The first is positioned at the bottom of the well to extract only water; this creates a depression cone that draws in the organic phase into the well. The second is positioned on the surface of the liquid at the LNAPL level and collects only the organic. A sensor system ensures that the two phases are collected separately. (C. J. Newell et al, US EPA Ground Water Issue Paper EPA/540/S-95/500, July 1995). In the Dual Well method, the pumps are placed in two different wells. There are also pumping systems coupled with active Skimmers, equipped with a floating inlet that is positioned on the water-hydrocarbon interface in the groundwater, limiting the inlet to the supernatant product only. Skimmers are also available with a selective filter positioned on the inlet of the floating system, which prevents water from entering the system even in the case in which the float momentarily becomes stuck in the flow (QED, Free Product Recovery Equipment Catalog). The pump with Skimmer can be used in a Dual Pump configuration in synergy with a second water draining pump.

A selective Skimmer variant was introduced by Abanaki (https://www.abanaki.com/product/petroxtractor-well-oil-skimmer/) with the PetroXtractor Well Oil Skimmer model. The heart of the system is the selective water-repellent belt, which, passing through both phases, absorbs only the organic phase and, with continuous rotation, always exposes a “clean” portion to the liquid, thus removing large volumes of organic matter (up to 45 litres/hour). During rotation the belt passes through a brush system that removes the organic matter from the surface and sends it to a collection system. In this way, the belt is continuously reusable. The belt is lowered into the well while the pulley is on the surface.

The Soil Vapor Extraction (SVE) method is a technique used for extracting volatile contaminants in the unsaturated zone of the groundwater (H. Kim et al, Environmental Science & Technology, 46 (2012) 9533-9540) and results in the removal of substances present in the vapour phase either as separated organic matter (LNAPL) or in aqueous solution. It involves sending a flow of air into the soil and collecting the extracted vapour through appropriate wells constructed in the vadose zone. The continuous flow of air produces a stripping of the vapours and the consequent evaporation of the new liquid phase and thus the gradual consumption of the contaminant in the soil. The gas, rich in pollutants, is finally sent to treatment units present on the surface.

Another method for removing the LNAPL phase is Soil Flushing (SF) which provides for the following steps:
injection of an aqueous solution with “cleaning” action into the contaminated area,
pumping of the mixture of groundwater and elutriate (mixture of the flushed solution and contaminants) to the surface,
treatment of the liquid collected for reuse or remediation.

Solutions of chemical compounds such as surfactants, solvents, acids, bases, oxidants, and chelating agents can be used; their function is to improve recovery efficiency by increasing the water solubility of the contaminant or its mobility (many organic pollutants have low solubility in water and tend to adsorb on the rocks of the soil) (S. Paria, Advances in Colloid and Interface Science, 138 (2008), p. 24-58).

The biological treatment (Bioremediation) (B.K. Yadav et al., Water Air Soil Pollut 220 (2011) p. 225-239) consists of stimulating the activity of indigenous microorganisms, present in the aquifer, by adding nutrients (nitrogen-and phosphorus-based), as well as an electron acceptor (generally oxygen). Microorganisms (bacteria, yeasts, fungi) use the contaminants as a source of nourishment, and thus cause their removal. The reaction generally leads to complete mineralisation. In this process, the mobilisation of NAPLs by surfactants accelerates degradation.

Many of the illustrated systems are characterized by a presence of water in the extracted liquid in such quantities as to require a surface separation post-treatment involving high water disposal/treatment costs.

Organic matter filtration or removal systems that have a fixed positioning inside the well, or in any case with limited stroke of the floating system, are not particularly effective in the event of significant variations in the depth of the groundwater. If the groundwater rises, immersion of the filtering element would occur, resulting in an abnormal recovery of water, while if the groundwater lowers, the device could be positioned so that it cannot filter and remove the organic component.

Generally, the pneumatic pumps used in the recovery devices show a tendency to fouling due to the accumulation of solids in the pump body. This causes repeated blockages and frequent maintenance. In addition, operation with compressed air causes, as an undesirable effect, the formation of liquid-air mixtures at the outlet, and the presence of multiphase prevents the use of reliable quantification systems for the total drained, as well as being critical for flammability issues.

The “in situ flushing” variant has a better recovery efficiency, but it implies the use of additional chemicals and complicates the treatment plant by adding injection wells. In addition, the availability of chemicals can be a problem at some specific sites. Bioremediation is a long and delicate process, in which close control and careful evaluation of the operating conditions (nutrient and oxygen level, interactions of nutrients with the soil, environmental conditions) are required to allow for a proper proliferation of the microorganisms and the effectiveness of this process. It may be useful to inject chemical compounds such as surfactants to promote the mobilization of the contaminants.

The SVE requires the construction of complex boundary utilities for gas flushing and extraction.

Hydrophobic Skimmers (Abanaki) that work by selective absorption on a rotating belt require frequent maintenance and control. The energy consumption due to the continuous rotation of the absorbent material is not negligible and they have reduced efficiency for the removal of low-viscosity hydrocarbons (V. Broje et al, Environ. Sci. Technol. 40(24 ) (2006), 7914-7918). The recovery methods with pumping systems (P&T, MPE, Skimmer, etc.) are simple systems focused only on remediation and do not provide for a simultaneous evaluation of the monitoring (residual hydrocarbon thickness, phreatimetric levels, total recovered from the well) and process parameters.

The different known systems described above do not fully meet the increasingly stringent requirements for the remediation of contaminated sites, balancing the need for fast, effective and low-cost interventions.

### SUMMARY

Aim of the present disclosure is to realise an equipment and a process overcoming the drawbacks of the prior art, enabling the removal of a separated non-aqueous supernatant phase from a body of water effectively, quickly and with a lower cost impact. The equipment also allows the monitoring of parameters useful for the remediation of a polluted groundwater.

The disclosure relates to a compact equipment for removing a non-aqueous supernatant phase from a body of water that is capable of performing selective recovery and pumping of the supernatant, as well as the measurement and monitoring of parameters such as, for example, the residual thickness of supernatant, phreatimetric levels, total recovered from the well, and daily flow rate. The disclosure allows the optimization of the remediation and guarantees the minimization of the residual thickness of the supernatant phase present in the body of water.

Aim of the present disclosure is therefore an equipment 100 for removing a non-aqueous supernatant phase 30 from a body of water in a well 10, the equipment 100 being characterized in that it comprises:
a first stilling tube 130 comprising a perforated hollow cylindrical casing extending for a predefined length according to the longitudinal axis of symmetry of the first stilling tube 130, provided with an upper flange 140 and a lower flange 160, the following components being installed inside the first stilling tube 130: a sliding rod 120 having a predefined length greater than or equal to that of the first stilling tube 130, arranged with its longitudinal axis parallel to the axis of symmetry of the first stilling tube 130, integral with the upper flange 140 and with the lower flange 160, a float 500 provided in the upper part with a hydrophobic filter 510 through which the supernatant phase 30 is filtered to be removed, the float 500 being slidably engaged on the sliding rod 120;
a pumping device 300, located below the lower flange 160, for collecting the supernatant phase 30 and sending it to the surface via a first recovery duct 900;
a second flexible tube 170 which fluidically connects the hydrophobic filter 510 to the pumping device 300 transferring by gravity the recovered supernatant phase 30 through the hydrophobic filter 510;
at least one first pressure sensor 700 installed between the lower flange 160 and the pumping device 300;
at least one second phase sensor 710 installed on the upper flange 140;
a support 110 for hooking and suspending the equipment 100, integral with the sliding rod 120.

The present disclosure is also a process for removing a non-aqueous supernatant phase from a contaminated body of water as described hereinafter.

### BRIEF DESCRIPTION OF THE DRAWINGS

Further characteristics and advantages of the present disclosure will become clear from the following description of a non-limiting example of an embodiment thereof, with reference to the figures of the attached drawings, in which:

FIG. 1 is a simplified schematic view with parts removed for clarity of the equipment 100, inserted into a well 10;

FIGS. 2 to 5 represent simplified diagrams of the operation of the pumping device in the various steps of use (pressurization, filling, supernatant emptying, water emptying);

FIG. 6 represents a simplified diagram of the operation of the equipment in the step of washing the filtering cartridges;

FIGS. 7a to 7c represent simplified diagrams of the positioning of the equipment depending on the thickness of the supernatant phase present in the well; and

FIG. 8 represents a graph correlating the supernatant level measured through the equipment subject-matter of the disclosure and instruments of known art (interface).

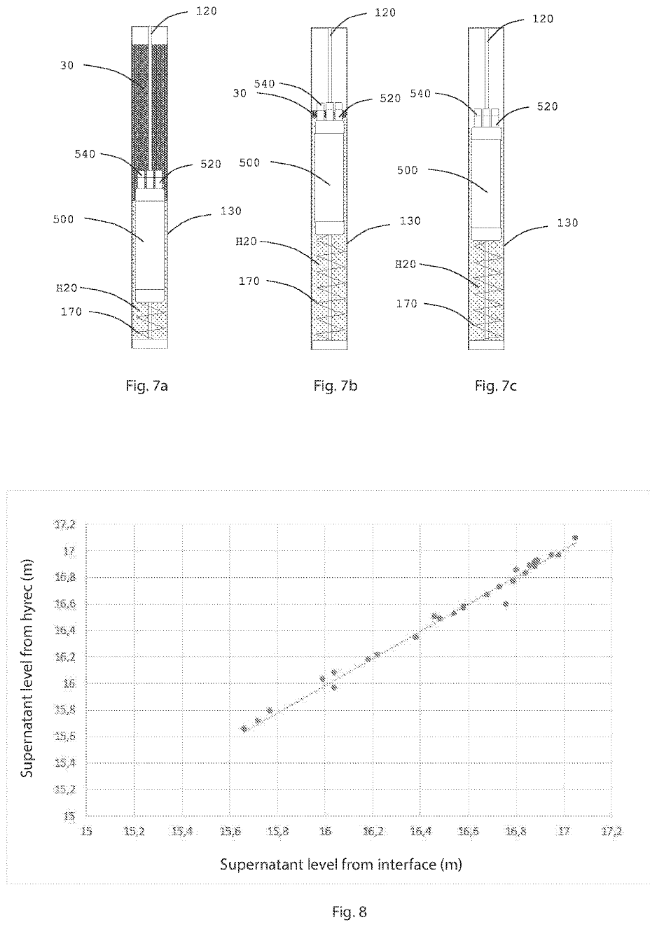

### DETAILED DESCRIPTION OF THE DRAWINGS

In the context of the present disclosure, a supernatant phase (Light Non Aqueous Phase Liquid—LNAPL), present in a body of water, is defined as a phase separated from other phases with a specific gravity less than that of water, so as to create a floating layer above the water level present in the groundwater. In the context of the present disclosure, the term “upper” is to be understood as indicating a position closer to the surface, while the term “lower” is to be understood as indicating a position closer to the bottom of the well 10.

The present disclosure is applied in a context in which a contaminated body of water contains at least one separated non-aqueous phase 30.

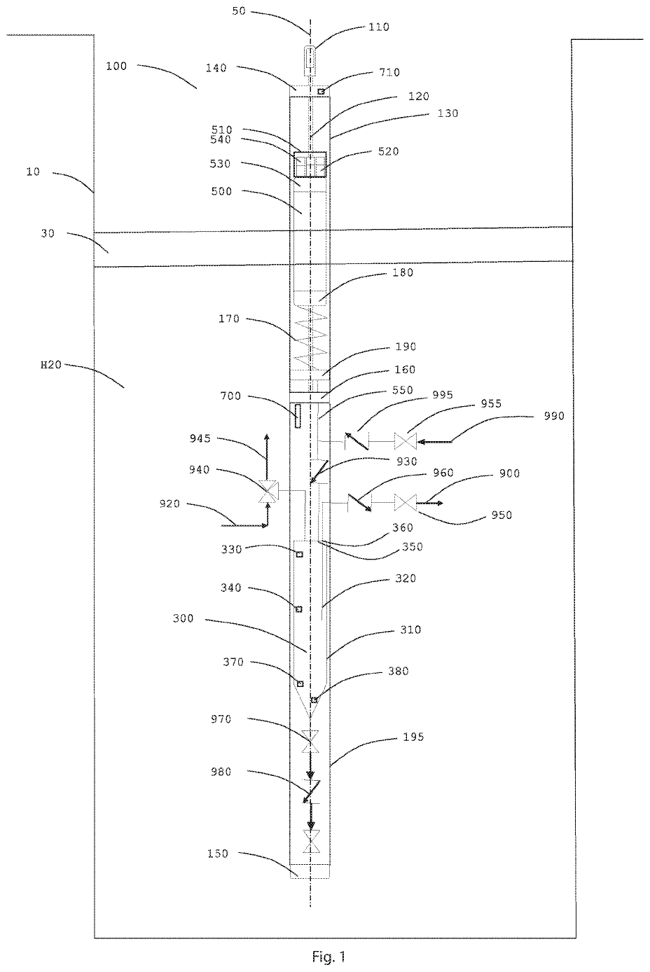

With reference to FIG. 1, an object of the present disclosure is an equipment 100 for removing a non-aqueous supernatant phase 30 from a body of water in a well 10. The equipment 100 comprises a first stilling tube 130 comprising a perforated hollow cylindrical casing extending for a predefined length according to the longitudinal axis of symmetry of the first stilling tube 130, provided with an upper flange 140 and a lower flange 160. The first stilling tube 130 provides adequate protection for the components installed therein and described below; it also acts as a coarse filter for any particles present in the groundwater fluid, preventing them from coming into contact with the functional elements installed inside the first tube 130. The first stilling tube 130 is delimited at the top by an upper flange 140 and at the bottom by the lower flange 160.

Within the volume defined by the first stilling tube 130 and the upper 140 and lower 160 flanges, there is a sliding rod 120 having a predefined length equal to or greater than that of the first stilling tube 130, arranged with its longitudinal axis parallel to the axis of symmetry of the first stilling tube 130, integral at the top with the upper flange 140 and at the bottom with the lower flange 160.

The equipment 100 is equipped with a float 500, provided in the upper part with a hydrophobic filter 510 through which the supernatant phase 30 is filtered to be removed, the float being slidably engaged on the sliding rod 120. The sliding rod 120 then acts as a sliding guide rail for the float 500, which is then subject to vertical movement depending on the level and type of fluid in which the equipment 100 is immersed. The float 500, depending on its vertical positioning and the variation of the water level and the supernatant phase 30, allows the hydrophobic filter 510 to intercept the supernatant phase 30 to remove it from the polluted body of water. The float 500 then, following the oscillations of the body of groundwater compatible with the available stroke, allows to selectively recover the supernatant phase 30 by means of the hydrophobic filter 510.

The supernatant phase 30 portion collected through the hydrophobic filter 510 is sent to a pumping device 300, located below the lower flange 160, for sending to the surface via a first recovery duct 900. For this purpose, a second flexible tube 170 fluidically connects the hydrophobic filter 510 to the pumping device 300, transferring by gravity the recovered supernatant phase 30. The second flexible tube 170 preferably extends helically between the hydrophobic filter 510 and the pumping device 300.

In order to establish the supernatant phase 30 level, when the equipment 100 is first used and for monitoring during operation the variation of the same level, the equipment 100 is provided with at least a first pressure sensor 700 installed between the lower flange 160 and the pumping device 300 and with at least a second phase sensor 710 installed on the upper flange 140. As further detailed below, the combination of the information provided by the aforementioned first and second sensors 700, 710 allows the precise determination of the supernatant phase 30 level and its thickness.

The equipment 100 is lowered and moved vertically in the well by means of a cable, a chain or equivalent means that connect to a support 110 for hooking and suspending the equipment 100, integral with the sliding rod 120.

In a preferred configuration of the disclosure, the equipment 100 is provided with a pumping device 300 of the pneumatic type which comprises a hollow body 310, a first non-return valve 930 which intercepts the supernatant phase 30 at the inlet to the pumping device 300 through a first opening 350 in the hollow body 310, a second opening 360 for delivery of the supernatant phase 30 to the surface, a third dip tube 320 protruding within the body 310 and connected to the second opening 360, a second non-return valve 960 installed at the outlet of the second opening 360 fluidically connected to the first recovery duct 900, a first pneumatic line 920 which supplies compressed air at a first pumping pressure P1 (preferably within a range between 1.5 relative bars and 10 bars relative), coming from the surface, intercepted by a first solenoid valve 940 equipped with a third vent line 945 connected to the hollow body 310 for selective pressurization of the same, a second solenoid valve 950 inserted on the recovery duct 900 which allows through the joint action of the solenoid valve 940 the pressurization of the pump body 310 allowing the closure of the valve 930 and preventing the access of fluid in any phase of operation of the pump, a high level third sensor 330 and a low level fourth sensor 340 for measuring the supernatant phase 30 portion collected in the hollow body 310. The third dip tube 320 protrudes inside the hollow body 310 preferably up to a level lower than the sensor 340. The pneumatic pumping device 300 cyclically allows the filling of the hollow body 310 with supernatant phase 30 coming by gravity from the hydrophobic filter 510 and the subsequent emptying by pressurization of the hollow body 310; the expulsion of the collected supernatant phase 30 to be sent to the surface is achieved by selective activation of the first solenoid valve 940, which introduces pressurized air into the hollow body 310, increasing its internal pressure; the increase in pressure causes the closure of the first non-return valve 930, the subsequent selective opening of the second solenoid valve 950 allows the collected phase 30 to be sent to the surface. The second non-return valve 960 prevents reflux from the surface to the equipment 100 of the recovered supernatant phase 30 present in the recovery duct 900. The function of the non-return valve 930, on the other hand, is to allow the entry of the supernatant phase 30 from the hydrophobic filter 510 into the hollow body 310 when not pressurized, avoiding its reflux towards the filter 510 itself when the hollow body 310 is pressurized to push the phase 30 towards the surface.

In a further preferred embodiment of the disclosure, the pumping device 300 comprises, in the lower part of the hollow body 310, a portion, preferably frustoconical, for collecting and discharging any water present in the supernatant phase 30 portion recovered through the hydrophobic filter 510, a first probe 370, preferably conductimetric, a second probe 380, preferably conductimetric, and a third discharge solenoid valve 970 selectively actuated on the basis of the signals from the first and second conductimetric probes 370, 380 for the release of the collected water into the groundwater.

Although the equipment 100 subject-matter of the disclosure has been designed to maximise the recovery of the supernatant phase 30 by reducing to the maximum its residual thickness in the body of groundwater, it is possible for a small amount of water to remain trapped in the hollow body 310 downstream of the filtration of the supernatant phase 30, due to leaks in the system or due to a rise in the groundwater level beyond the stroke of the float. In order to prevent the collected water from being sent to the surface together with the supernatant phase 30 present in the hollow body 310, the equipment 100, in a preferred configuration, is provided with a system for purging said collected water directly into the groundwater; for this purpose, the lower portion of the hollow body 310 acts a container for the volume of collected water that is selectively emptied through the third discharge solenoid valve 970 driven by signals from the first probe 370 that signals that the water has reached a predetermined high level and from the second probe 380 that signals that the water is below a predetermined minimum level. With reference to FIG. 5, pressurization of the hollow body 310 by opening the first solenoid valve 940 and blocking the first non-return valve 930 with the second solenoid valve 950 closed causes the collected water to be discharged when the third solenoid valve 970 opens.

In a further preferred embodiment of the disclosure as described above, the equipment 100 comprises a protective casing 195 extending from the lower flange 160 for a predefined length to a lower closure 150; the casing 195 protects the components inserted therein such as, for example, the pumping device 300, the first pressure sensor 700 and the third water discharge solenoid valve.

In a further preferred embodiment of the disclosure, the sliding rod 120 of the equipment 100 is hollow and at least one pneumatic line and at least one signal line connected to the components installed in the equipment 100 are arranged inside it. As can be seen from what has been described, the equipment 100 is provided with solenoid valves, at least one pneumatic line, and the signal lines to convey information from the installed sensors to a control unit. In order to make the equipment 100 of the disclosure more compact, the aforementioned pneumatic and electrical signal lines are configured to pass through the hollow space of the sliding rod 120, reducing the external overall dimensions and rationalising the space.

In a further preferred embodiment of the disclosure, the hydrophobic filter 510 of the equipment 100 comprises a plurality of filtering cartridges 520, preferably six, arranged on a manifold 530 which conveys the filtered supernatant phase 30 to the second flexible tube 170. The specific conformation of the hydrophobic filter 510 containing a plurality of cartridges 520 makes the equipment 100 easy to construct as it relies on commercially available cartridges 520 without the need to make custom-made hydrophobic filters depending on the dimensions of the equipment 100. Furthermore, with the same volume occupied by the installed hydrophobic filter 510, the presence of multiple filtering cartridges 520 increases the filtering surface, positively impacting the filtration capacity both in terms of quality and in terms of quantity of treated supernatant phase 30.

In a further preferred embodiment of the disclosure, each filtering cartridge 520 has a substantially cylindrical shape, arranged in use with its longitudinal axis parallel to the longitudinal axis of symmetry of the first stilling tube 130, and is provided in upper part with a holed plug 540 for the passage of the supernatant phase 30, the plug 540 being provided with a membrane which prevents the flow of fluid from inside of the filtering cartridge 520 towards the outside. With this particular conformation of the filtering cartridges 520 and with a predetermined choice of the density value of the float 500, when the level of supernatant phase 30 is above the maximum height of the same cartridges 520, it is reasonable to assume that supernatant phase 30 can be recovered without the danger of water being retained in the pumping device 310. In this situation of a high level of supernatant phase 30, it is therefore possible to bypass the filtering part of the cartridges 520 and have the supernatant phase 30 directly enter through the perforated plugs 540. This increases the flow rate of recovered phase 30, decreasing pressure losses due to filtering and also reducing the clogging of the filters. When the supernatant phase 30 level moves below the perforated plugs 540, the filtering cartridges 520 work in a conventional manner by treating the supernatant phase 30 through the hydrophobic matrix.

In a further preferred embodiment of the disclosure, the equipment 100 comprises a first spacer 180 integral with the lower part of the float 500 and a second spacer 190 arranged above the lower flange 160 and the second flexible tube 170 extends between the first spacer 180 and the second spacer 190. The conformation of the spacer 190 allows the settling of particulate matter penetrated inside the stilling tube 130 in the volume between the upper flange 140 and the second spacer 190. The particular configuration of the two spacers 180, 190 allows the adoption of a flexible tube 170 that changes its length between the spacers, guaranteeing flexibility to the movements of the float 500 without blockades in its sliding; the preferably helical arrangement of the flexible tube 170 prevents it from bending incorrectly with the risk of partial or total occlusion of the same during the movement of the float 500.

A control unit, located on the surface and electrically connected to the equipment 100, located in the well 10, controls the power supply of the equipment 100, the acquisition and processing of signals from the sensors 700, 710, 330, 340, 370, 380; the control unit sends signals for starting or stopping the pumping device 300 on the basis of the signals from the sensors 330, 340 and it discharges water on the basis of the signals from the sensors 370, 380. The control unit also displays, on the basis of the signals from the sensors 700, 710, data relating to the thickness of the supernatant phase 30, the phreatimetric level and the signals for repositioning the equipment 100 on the basis of the supernatant phase 30 level. The control unit manages and displays blocking events due to malfunctions, on the basis of signals from the sensors 700, 710, 330, 340, 370, 380. Data relating to the pressure of the pressurization conduit 920, the operating/sealing status of the valves of the hollow body 310 and the power supply voltage are obtained through further sensors placed on the control unit. It is possible to set some parameters on the control unit such as, for example, a groundwater depth value which is useful for some measurements carried out by the equipment 100 as better described below.

A process for removing a supernatant phase 30 from a contaminated body of water in order to minimise the recovery of polluted groundwater to be subsequently treated on the surface with an obvious increase in costs is also an object of the present disclosure; the process relies on the flexibility guaranteed by the equipment 100 through the mobility of the float 500 and the presence of the hydrophobic filter 510 to minimize the residual thickness of the supernatant phase 30. In this way, the recovery of the supernatant phase 30 is optimized, minimizing the pumping of polluted water.

An object of the present disclosure is therefore a process for removing a non-aqueous supernatant phase 30 from a body of water in a polluted groundwater comprising the steps of:
a) providing the equipment 100 according to the claims;
b) lowering the equipment 100 through a well 10 into a body of water in a polluted groundwater having previously pressurized the hollow body 310 by opening the first solenoid valve 940 and closing the second solenoid valve 950 and the third solenoid valve 970;
c) detecting the presence of non-aqueous supernatant phase 30 by means of signals from the first pressure sensor 700 and from the second phase sensor 710;
d) positioning the equipment 100 so that the float 500 is in the middle of its effective stroke based on the pressure value measured by the first pressure sensor 700 and on the known density of the float 500;
e) filling the hollow body 310 by closing the first solenoid valve 940 and opening the third vent line 945 allowing the supernatant phase 30 to enter the hollow body 310 through the opening 350;
f) when the third sensor 330 detects the presence of collected phase 30, pressurizing the hollow body 310 by opening the first solenoid valve 940, closing the first non-return valve 930 and, subsequently, opening the second solenoid valve 950, emptying the hollow body 310 through the third dip tube 320 and the first recovery duct 900 by means of the pressure exerted through the first pneumatic line 920;
g) stopping emptying the hollow body 310 when the fourth sensor 340 does not detect the presence of collected phase 30, closing the second solenoid valve (950) and subsequently the first solenoid valve (940);
h) cyclically repeating steps e) to g);
i) interrupting the removal process of the supernatant phase (30) when the second phase sensor 710 detects the presence of water or when the first pressure sensor 700 detects a pressure value outside a predetermined pressure range. The interruption takes place by pressurizing the hollow body 310 by selectively closing the second solenoid valve 950, the third solenoid valve 970 and the third vent line 945 and opening the first solenoid valve 940. In this way, the pressurized air from the first pneumatic line 920 enters the hollow body 310 closing the first non-return valve 930.

The process subject-matter of the disclosure provides for the of the equipment 100 in which the pumping device 300 is of pneumatic type as described above.

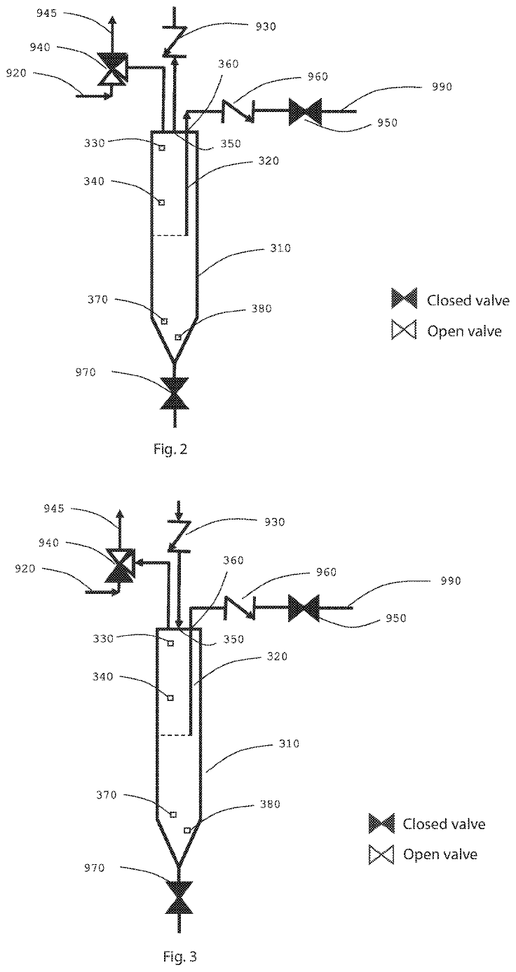

With reference to FIG. 2, the equipment is manually lowered into a well 10 having previously pressurized the hollow body 310. This is done by selectively closing the second solenoid valve 950, the third solenoid valve 970 and the third vent line 945 and opening the first solenoid valve 940. In this way, the pressurized air from the first pneumatic line 920 enters the hollow body 310 closing the first non-return valve 930. This prevents liquid from entering the pumping device 300 during the descent of the equipment 100 and its immersion in the body of polluted water. Thereafter, the equipment 100 is lowered into the body of polluted water until water is detected by the second phase sensor 710. At this point, the equipment 100 is slowly lifted in a controlled manner until the second phase sensor 710 no longer detects water (interface between water and oil or water and air); the pressure value measured by the first pressure sensor 700 is then acquired; the thickness of the supernatant phase 30 can be obtained by calculating the difference between the previously measured pressure value and the pressure value of the water column of known height as a result of the geometry of the equipment 100, and dividing this pressure difference by the density of the supernatant phase 30 previously established. The equipment 100 is then lifted in the well positioning the float 500 in the middle of its available stroke based on the pressure value measured by the first pressure sensor 700 (and thus the known hydraulic head) and on the known density of the float 500; for the purposes of determining the positioning of the float 500 in the middle of its available stroke, the contribution of the hydraulic head of the possible supernatant phase (30) present is considered negligible. The 100 equipment is then stopped in position and the step of recovery of supernatant phase 30 begins via the hydrophobic filter 510. The collected supernatant phase 30 is conveyed by gravity to the pneumatic pumping device 300 through the second flexible tube 170 and the second conduit 550. With reference to FIG. 3, in order to facilitate filling of the hollow body 310, the first solenoid valve 940 is closed and the third vent line 945 is opened to atmosphere; in this way the first non-return valve 930 allows the filtered phase 30 to pass. When the collected supernatant phase 30 level reaches the high level third sensor 330, the sending of the supernatant phase 30 to the surface with emptying of the hollow body 310 is triggered. For this purpose, with reference to FIG. 4, the hollow body 310 is again pressurized by opening the first solenoid valve 940 and closing the third vent line 945. The increase in pressure within the hollow body 310 causes the first non-return valve 930 to close, interrupting the flow of supernatant phase 30 entering the pumping device; the subsequent opening of the second solenoid valve 950 allows the content of the pumping device 300 to be conveyed to the surface by means of the first recovery duct 900. While emptying the hollow body 310, the phase 30 level falls until it reaches the low level fourth sensor 340; as soon as this condition occurs, the operations of emptying the hollow body 310 are interrupted by closing the second solenoid valve 950 and, subsequently, the first solenoid valve 940.

The operations of filling and subsequent emptying the pneumatic pumping device 300 can be repeated cyclically based on the signals from the high level third sensor 330 and the low level fourth sensor 340.

The mode of operation of the pumping device 300, based on the signals of the high level third sensor 330 and the low level fourth sensor 340, and its geometry of construction prevent both the entry of air into the third dip tube 320 and the fouling of the device itself, avoiding the blockades typical of the conventional pumping systems.

The logic described above, which governs the filling and emptying of the hollow body 310 of the pumping device 300, allows an accurate measurement of the amount of recovered phase 30. Since the emptying of the hollow body 310 begins when the high level third sensor 330 detects the presence of fluid and after the valve 930 has closed due to the pressurization of the hollow body 310 by opening the first solenoid valve 940 and closing the third vent line 945, and stops when the low level fourth sensor 340 no longer detects the presence of fluid, the volume of phase 30 pumped to the surface is known from the geometry and positioning of the sensors 330 and 340. It is therefore possible to accurately measure and account for the recovered volumes of phase 30.

The interruption of the removal process of the supernatant phase 30 is governed by the signals from the second phase sensor 710 or from the first pressure sensor 700; when the presence of water is detected through the second phase sensor 710 or when, through the first pressure sensor 700, a pressure value outside a predetermined pressure range is detected, the removal process of the supernatant phase 30 is interrupted. The predetermined pressure range and, consequently, the level of water in the well is defined on the basis of the total stroke, density and dimensions of the float 500 in order to prevent the float 500 from coming to rest below and above at the end of the stroke.

Further object of the present disclosure is the method for removing a non-aqueous supernatant phase 30 from a body of water in a polluted groundwater described above comprising measuring the thickness of the supernatant phase 30. This measurement is carried out by keeping the hollow body 310 pressurized as described above; the equipment 100 is then immersed in the body of water until the second phase sensor 710 detects water, thus causing the upper flange 140 to be fully immersed in water. Subsequently, the equipment 100 is slowly raised until the second phase sensor 710 detects the presence of supernatant phase 30. In this position, the pressure value is measured by the first pressure sensor 700. At this point, it is possible to obtain the thickness of the supernatant phase 30 by calculating the difference between the previously measured pressure value and the pressure value of the water column of known height as a result of the geometry of the equipment 100, and by dividing this pressure difference by the density of the supernatant phase 30 previously established.

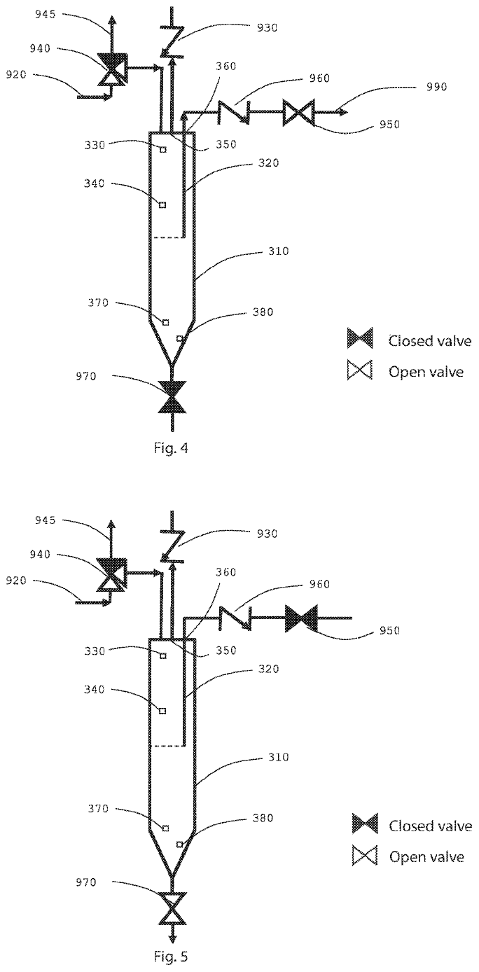

It is known that the use of hydrophobic filters for the recovery of LNAPLS leads to their fouling proportionally to the volume of treated liquid. With reference to FIG. 6, in order to limit this phenomenon and increase the availability of the equipment 100, a further object of the present disclosure is the method for removing a non-aqueous supernatant phase 30 from a body of water in a polluted groundwater described above comprising the steps of:
setting up the equipment 100 provided with a second conduit 550 which fluidically connects the second flexible tube 170 from the second spacer 190 to the pumping device 300, a second pneumatic line 990, which supplies compressed air at a second washing pressure P2 (within a range between 0.5 relative bars and 1 relative bar) lower than the first pumping pressure P1, which engages on the second conduit 550 above the first non-return valve 930, a fifth non-return valve 995 and a fourth valve 955 which are installed on the second pneumatic line 990;
pressurizing the hollow body 310 by opening the first solenoid valve 940 and closing the second solenoid valve 950 and the third solenoid valve 970;
opening the fourth valve 955 and blowing compressed air at the second washing pressure P2 through the second pneumatic line 990;
flowing the compressed air through the second duct 550 and the second flexible tube 170 to the filtering cartridges 520;
flowing the compressed air from the filtering cartridges 520 in the opposite direction to the inlet direction of the supernatant phase 30, causing the closure of the perforated plugs 540 by means of the membranes and carrying out a counter-current cleaning of the filtering cartridges 520.

By means of the counter-current washing cycle of the filtering cartridges 520 it is possible to regenerate the hydrophobic filtering capacity of the equipment 100 avoiding the downtime of the remediation operations for long periods which are otherwise necessary for the replacement of the filtering cartridges 520. In this way it is possible to maintain a high filtering capacity of the equipment 100 and its availability over time.

During the counter-current washing cycle of the filtering cartridges 520, the prior pressurization of the hollow body 310 by the first pumping pressure P1 causes, as already described, the closure of the first non-return valve 930; the subsequent blowing of compressed air at the second washing pressure P2 lower than the first pumping pressure P1 allows the compressed air to flow through the second conduit 550 towards the hydrophobic filtering cartridges 520 without entering the hollow body 310 since the first non-return valve 930 remains in a closed state due to the difference between the first pumping pressure P1 and the second washing pressure P2.

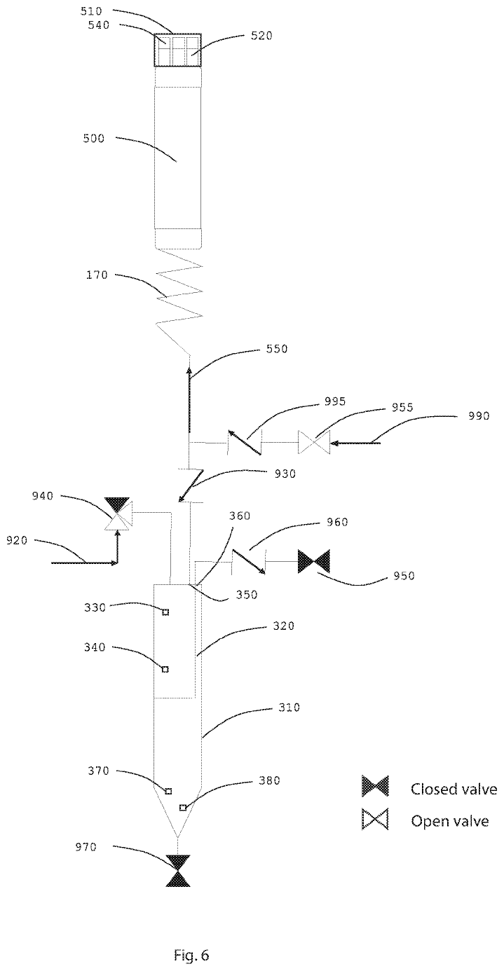

By way of example, FIGS. 7a, 7b and 7c show the operation of the equipment as the supernatant phase 30 level varies. In particular, FIG. 7a illustrates the operation of the equipment 100 when there is a layer of supernatant phase 30 greater than the maximum height of the hydrophobic filter 510. In this situation the hydrophobic filter 510 is completely immersed in the supernatant phase 30 and totally connected to the filtering and recovery of the pollutant. In the preferred embodiment in which the hydrophobic filter 510 comprises the filtering cartridges 520 described above, part of the supernatant phase 30 may bypass the filtering surface and enter directly into the hollow body 310 by means of the perforated plugs 540. This increases the capability of the equipment 100 to dispose of the supernatant phase 30 without the risk of retaining water and reducing the clogging of the filters 520.

With reference to FIG. 7b, the supernatant phase 30 level is lower than the maximum height of the hydrophobic filter 510, in this situation the supernatant phase 30 is processed by filtration through the walls of the hydrophobic filter 510.

In the operation described in FIGS. 7a and 7b, the pumping device 300 can be selectively cyclically activated both manually and automatically by the control unit for disposal of the recovered phase 30 on the surface.

With reference to FIG. 7c, the thickness of the supernatant phase 30 is lower than a predefined minimum value and in this case the recovery and filtering activity is reduced to a minimum and the pumping device 300 is not activated.

The positioning of the equipment 100 in the well is normally carried out so that the float 500 is in the middle of its available stroke, using the measurement of the pressure of the liquid head with respect to the set reference value. The start at high thicknesses of supernatant phase 30 or in any case where a thickness measurement is not necessary, provides for the sole operation of positioning the float 500 in the middle of the stroke. The start at low thicknesses of supernatant phase 30 also implies a thickness measurement of the supernatant before positioning float 500 in the middle of the stroke.

During a pilot test, the supernatant phase 30 level measured by the equipment 100 and the level measured with known instruments (e. g. an “interface”) were compared. As can be seen from figure the equipment 100 proved to have an extreme measurement accuracy with an excellent correlation between the traditional measurements and those using the equipment 100.

A further object of the present disclosure is a method for measuring the phreatimetric level of a body of water in a polluted groundwater comprising the steps of:
measuring with an interface probe, known per se, a depth value with respect to the well 10 mouth of the water/supernatant phase 30 interface and of the supernatant/air phase 30 interface and, consequently obtaining the thickness of the supernatant phase 30;
when the thickness of the supernatant phase 30 is between 0 cm and 20 cm, lowering the equipment 100 into the well 10 until a value is obtained from the first pressure sensor 700 corresponding to a positioning of the float 500 in the middle of its stroke. In this way the equipment 100 will be positioned in the well 10 so that the float 500 is in the middle of its available stroke. This positioning is possible by means of the correlation between the measured pressure value, the density of the float 500 and the fluid head corresponding to the aforementioned pressure value, as described above. When this condition is reached, the float 500 is positioned in the middle of the effective stroke.
setting on the control unit the value measured with the depth interface probe with respect to the mouth-well of the supernatant/air phase 30 interface; this value is shown by a display included in the control unit.
starting from the value set in the control unit, calculating in real time, using the same unit, the depth value of the supernatant/air phase 30 with respect to the mouth-well based on the oscillation of the groundwater level by means of the corresponding reading of the pressure value measured by the first pressure sensor 700 so that an increase in the pressure value measured by the first pressure sensor 700 proportionally corresponds to a decrease in the depth value of the supernatant/air phase 30 interface with respect to the well-mouth, while a decrease in the pressure value measured by the first pressure sensor proportionally corresponds to an increase in the depth value of the supernatant/air phase 30 interface with respect to the well-mouth. The calibration adopted by the equipment 100 considers a pressure variation by 1 millibar measured by the first pressure sensor 700 to be equivalent to a depth variation of the supernatant/air phase 30 interface with respect to the mouth-well equal to 1 cm (a positive pressure variation corresponds to a decrease in the depth of the interface and vice versa).

In the event that the need arises to reposition the equipment 100, the depth value with respect to the mouth-well of the supernatant/air phase 30 interface that is set on the control unit is the last depth value calculated by the control unit prior to repositioning.

The equipment 100 subject-matter of the disclosure makes it possible to remediate a polluted body of water with higher performance than known techniques both in terms of supernatant phase residue present in the body of water and in terms of the quality of recovered supernatant phase 30 (selective system). These results are achieved with a compact and simple equipment with reduced energy consumption compared to the devices of the prior art.

The process described thus allows to effectively and selectively manage the collection and evacuation of the recovered supernatant phase 30; moreover, as described above, the equipment 100 is only operating when necessary, i.e. when a supernatant phase 30 is present.

In addition to performing the reclamation of a polluted body of water, the device also measures various parameters of interest such as, for example, the residual thickness of the supernatant phase, the phreatimetric levels, the total recovered from the well, the daily flow rate, the average flow rate, the line pressure, the mains voltage, the flow rate of the recovery pump, the well water temperature, allowing to direct the reclamation activity on the most impacted areas.

In addition, the device guides the operations carried out by the operator, such as repositioning for changes in the levels beyond the working range and the measurement of residual thickness of supernatant, and can report by e-mail or text message the presence of blockades, malfunctions and detected values, in addition to providing in a programmed or manual way for the in-line automatic counter-washing procedure of the hydrophobic filters, reducing the frequency of replacement and maintenance. The equipment 100 for removing a supernatant phase 30 from a contaminated body of water, which is the subject-matter of the present disclosure as thus conceived, is susceptible in each case to numerous modifications and variants, all of which fall within the same inventive concept; moreover, all the details may be replaced by technically equivalent elements. In particular, the sensors 700, 710, may be of various shape and type as available on the market. The level sensors within the pumping device applicable to the present disclosure are all those that allow to precisely identify the different fluids involved in the process (oil, water, air). The hydrophobic filter 510 and the filtering cartridges 520 may be of various dimensions and types as commercially available. The materials used, as well as the shapes and dimensions, may in practice be of any type according to the technical requirements.

The protective scope of the disclosure is therefore defined by the appended claims.

1. An equipment for removing a non-aqueous supernatant phase from a body of water in a well, the equipment comprising:
a first stilling tube comprising a perforated hollow cylindrical casing extending for a predefined length according to the longitudinal axis of symmetry of the first stilling tube, provided with an upper flange and a lower flange, the following components being installed inside the first stilling tube: a sliding rod having a predefined length greater than or equal to that of the first stilling tube, arranged with its longitudinal axis parallel to the axis of symmetry of the first stilling tube, integral with the upper flange and with the lower flange, a float provided in the upper part with a hydrophobic filter through which the supernatant phase is filtered to be removed, the float being slidably engaged on the sliding rod;
a pumping device, located below the lower flange, for collecting the supernatant phase and sending it to the surface via a first recovery duct;
a second flexible tube which fluidically connects the hydrophobic filter to the pumping device transferring by gravity the recovered supernatant phase through the hydrophobic filter;
at least one first pressure sensor installed between the lower flange and the pumping device;
at least one second phase sensor installed on the upper flange; and
a support for hooking and suspending the equipment, integral with the sliding rod.

2. The equipment according to claim 1, wherein the pumping device is of the pneumatic type and comprises a hollow body, a first non-return valve which intercepts the supernatant phase at the inlet to the pumping device through a first opening in the hollow body, a second opening for delivery of the supernatant phase to the surface, a third dip tube connected to the second opening a second non-return valve installed at the outlet of the second opening fluidically connected to the first recovery duct (900), a first pneumatic line, coming from the surface, intercepted by a first solenoid valve equipped with a third vent line, connected to the hollow body for selective pressurization of the same, a second solenoid valve which intercepts the recovery duct, a high level third sensor and a low level fourth sensor for measuring the supernatant phase portion collected in the hollow body, the third dip tube protruding up to a level lower than the sensor in the hollow body.

3. The equipment according to claim 2, wherein the pumping device comprises, in the lower part of the hollow body, a portion for collecting and discharging any water present in the supernatant phase portion recovered through the hydrophobic filter, a first probe, a second probe and a third discharge solenoid valve selectively actuated on the basis of the signals from the first and second probes for the release of the collected water into the groundwater.

4. The equipment according to claim 1, wherein the sliding rod is hollow and at least one pneumatic line and at least one signal line connected to the components installed in the equipment are arranged inside it.

5. The equipment according to claim 1, wherein the hydrophobic filter comprises a plurality of filtering cartridges arranged on a manifold which conveys the filtered supernatant phase to the second flexible tube.

6. The equipment according to claim 5, wherein each filtering cartridge has a substantially cylindrical shape, arranged in use with its longitudinal axis parallel to the longitudinal axis of symmetry of the first stilling tube, and is provided in upper part with a holed plug for the passage of the supernatant phase, the plug being provided with a membrane which prevents the flow of fluid from inside of the filtering cartridge towards the outside.

7. The equipment according to claim 1, further comprising a first spacer integral with the lower part of the float and a second spacer arranged above the lower flange and the second flexible tube extends helically between the first spacer and the second spacer.

8. The equipment according to claim 1, further comprising a second conduit which fluidically connects the second flexible tube from the second spacer to the pumping device, a second pneumatic line which engages on the second conduit above the first non-return valve, a fifth non-return valve and a fourth valve installed on the second pneumatic line.

9. A process for removing a non-aqueous supernatant phase from a body of water in a polluted groundwater, the process comprising the following steps of:
a) providing the equipment according to claim 2;
b) lowering the equipment through a well into a body of water in a polluted groundwater having previously pressurized the hollow body by opening the first solenoid valve and closing the second solenoid valve and the third solenoid valve;
c) detecting the presence and thickness of non-aqueous supernatant phase by means of signals from the first pressure sensor and from the second phase sensor;
d) positioning the equipment 100 so that the float 500 is in the middle of its effective stroke based on the pressure value measured by the first pressure sensor 700 and on the known density of the float 500;
e) filling the body by closing the first solenoid valve and opening the third vent line allowing the supernatant phase to enter the hollow body through the opening;
f) when the third sensor detects the presence of collected phase pressurizing the hollow body by opening the first solenoid valve closing the first non-return valve and, subsequently, opening the second solenoid valve emptying the hollow body through the third dip tube and the first recovery duct by means of the pressure exerted through the first pneumatic line;
g) stop emptying the hollow body when the fourth sensor does not detect the presence of collected phase, closing the second solenoid valve (950) and subsequently the first solenoid valve;
h) cyclically repeating steps e) to g;
i) interrupting the removal process of the supernatant phase when the second phase sensor 710 detects the presence of water or when the first pressure sensor 700 detects a pressure value outside a predetermined pressure range.

10. The process according to claim 9, a further comprising a step of measuring the thickness of the supernatant phase by the following steps:
pressurizing the hollow body by opening the first solenoid valve and closing the second solenoid valve and the third solenoid valve;
immersing the equipment in the body of water until the second phase sensor detects water;
rising the equipment in a controlled manner in the body of water up to the point where the second sensor detects supernatant phase; stopping the equipment and detecting the pressure at the level of the first pressure sensor;
obtaining the thickness of the supernatant phase of previously established density by calculating the pressure difference between the pressure value measured at the level of the first sensor and the pressure value due to the water column extending from the second phase sensor to the first pressure sensor and dividing said pressure difference by the density value of the supernatant.

11. The process according to claim 9, which comprises the steps of:
setting up the equipment;
closing the third water discharge solenoid valve,
pressurizing the hollow body by opening the first solenoid valve and closing the second solenoid valve and the third solenoid valve;
opening the fourth valve 955 and blowing compressed air at the second washing pressure P2 through the second pneumatic line 990;
flowing the compressed air through the second duct and the second flexible tube to the filtering cartridges;
flowing the compressed air from the filtering cartridges in the opposite direction to the inlet direction of the supernatant phase, causing the closure of the perforated plugs by means of the membranes and carrying out a counter-current cleaning of the filtering cartridges.

12. The process according to claim 9, further including the steps of:
measuring with an interface probe, known per se, a depth value with respect to the well mouth of the water/supernatant phase interface and of the supernatant/air phase interface and, consequently obtaining the thickness of the supernatant phase;
when the thickness of the supernatant phase is between 0 cm and 20 cm, lowering the equipment into the well until obtaining a value from the first pressure sensor corresponding to a positioning of the float in the middle of its stroke by means of the correlation between the measured pressure value, the density of the float 500 and the fluid head corresponding to the aforementioned pressure value;
setting on the control unit the measured depth value with respect to the mouth-well of the supernatant/air phase interface; and
starting from the value set in the control unit, calculating in real time, using the same unit, the depth value of the supernatant/air phase 30 interface with respect to the mouth-well based on the oscillation of the groundwater level by means of the corresponding reading of the value measured by the first pressure sensor so that an increase in the pressure value measured by the first pressure sensor proportionally corresponds to a decrease in the depth value of the supernatant /air phase interface with respect to the well-mouth, while a decrease in the pressure value measured by the first pressure sensor proportionally corresponds to an increase in the depth value of the supernatant/air phase interface with respect to the well-mouth.
